(19) United States
(12) Patent Application Publication
(10) Pub. No.: US 2010/0290534 A1
(43) Pub. Date: Nov. 18, 2010

(54) Video Encoding Using Pixel Decimation

(76) Inventor: Gyan Prakash Pandey, Bangalore (IN)

Correspondence Address: DLA PIPER LLP (US), 2000 UNIVERSITY AVENUE, EAST PALO ALTO, CA, 94303, US

(21) Appl. No.: 12/738,070

(22) PCT Filed: Oct. 13, 2008
(86) PCT No.: PCT/IB08/54204

§ 371 Date: Aug. 2, 2010

(30) Foreign Application Priority Data
Oct. 16, 2007 (JP) 07118597.9

(51) Int. Cl. H04N 7/26

(52) U.S. Cl. 375/240.24; 375/E07.026

(57) ABSTRACT

A method of video encoding comprising receiving an image, selecting a macroblock in the image, determining a best intra encoding mode for the macroblock, determining a pixel direction from the determined best encoding intra mode, and selecting a pixel decimation pattern according to the determined pixel direction.

This invention relates to a method and system for video encoding.

A video sequence is a sequence of images sampled in the time domain. Since the storage space required for most video sequences is relatively large, for a limited storage equipment or transmission bandwidth video data is often required to be compressed. Video compression is achieved by removing various redundancies present in the video data. One such redundancy present in video data is temporal redundancy, which refers to neighbouring frames in time domain being similar. Motion estimation is a compression technique widely used in video encoders to remove temporal redundancy.

The motion estimation process takes a block in a current frame and finds out the closest match for the current block in a reference frame (a previous or future frame in time domain). Finding out the closest match for the current block is done through a block matching criterion between current block and a similar size block in reference frame. One such criterion is finding SAD (sum of absolute differences of co-located pixels) between current block and a similar block in reference frame. Motion estimation involves pixel level operation and hence it is computationally intensive. There are two approaches for reducing the complexity of motion estimation in a video encoder namely search point reduction and pixel decimation.

Pixel decimation is based upon the premise that adjacent pixels in a frame/block are highly correlated, that is there luminance values are similar. Therefore, it is not necessary for every pixel in a block to be part of the SAD computation. Computational complexity in block matching can be reduced if the encoder skips few redundant pixel computations in block matching. This method of skipping of pixels from block matching computation is known as pixel decimation. For motion estimation in video encoders, the pixel decimation can be generally divided into two types, static pixel decimation and dynamic pixel decimation. The pixels to be skipped and pixels to be used in computation are fixed in static pixel decimation (e.g. ¼ pixel decimation). The implementation in this case is simple and quick, however static pixel decimation will perform poorly in case of pixel correlations not following any regular pattern over a time interval. For example if a rectangular bar is having a rotational motion in frames then static pixel decimation does not fit well with this scenario.

Dynamic pixel decimation will dynamically select set of pixels to be used in block matching computation. Depending upon the type of pixel correlation present in the block, dynamic pixel decimation technique may pick up different set of pixels for block matching computation. Thus dynamic pixel decimation adapts to changing pixel correlation in a block and is expected to give better result than static pixel decimation. However extra time will be required to determine set of redundant pixels which need not be part of block matching computation, hence increasing some computation burden of motion estimation.

An example of pixel decimation is shown in U.S. Pat. No. 5,475,446, which discloses a picture signal motion detector employing partial decimation of pixel blocks. In this document, a reference picture signal is stored defining a plurality of image pixels of a reference picture. The input picture signal is divided into a plurality of input block signals each defining a plurality of image pixels of a corresponding input block. Decimation information is set in advance for specifying a portion to be decimated among the plurality of image pixels of each input block. Selected image pixels of each of input blocks are addressed in accordance with the block decimation information to obtain a corresponding decimated input block having an addressed subset of image pixels relative to the plurality of image pixels of each input block. An image motion associated with each input block is estimated by comparing the addressed subset of image pixels of each corresponding decimated input block with the image pixels of the reference image.

The problem with all known pixel decimation schemes is that they are either static (using a single predefined decimation pattern), which does not provide a sufficiently flexible solution, or they are dynamic (using one of several predefined decimation patterns), but are therefore computationally inefficient, as processor cycles must be used to determine which pattern should be used.

It is therefore an object of the invention to improve upon the known art.

According to a first aspect of the invention, there is provided a method for video encoding comprising receiving an image, selecting a macroblock in the image, determining a best encoding mode for the macroblock, determining a pixel direction from the determined best encoding mode, and selecting a pixel decimation pattern according to the determined pixel direction.

According to a second aspect of the invention, there is provided a system for video encoding comprising a receiver arranged to receive an image, and a processor arranged to select a macroblock in an image, to determine a best encoding mode for the macroblock, to determine a pixel direction from the determined best encoding mode, and to select a pixel decimation pattern according to the determined pixel direction.

According to a third aspect of the invention, there is provided a computer program product on a computer readable medium for video encoding, the product comprising instructions for receiving an image, selecting a macroblock in the image, determining a best encoding mode for the macroblock, determining a pixel direction from the determined best encoding mode, and selecting a pixel decimation pattern according to the determined pixel direction.

Owing to the invention, it is possible to provide a dynamic pixel decimation solution that nevertheless does not increase the load on the processing, as information that is already produced in the encoding process is used to determine which of the pixel decimation patterns are to be used. In this invention a method is proposed for dynamic pixel decimation that can be used, for example, in an H.264 encoder.

Preferably, the method further comprises repeating the selecting a macroblock in the image, determining a best encoding mode for the macroblock, determining a pixel direction from the determined best encoding mode, and selecting a pixel decimation pattern according to the determined pixel direction, for each macroblock in the image. The dynamic selection of the pixel decimation pattern can be applied for every macroblock within the image to be encoded as a P or B slice, and no loss of processor cycles occurs as a result.

Advantageously, the method further comprises storing a plurality of pixel decimation patterns. Each stored pixel decimation pattern includes a header defining a pixel direction, and the step of selecting a pixel decimation pattern according to the determined pixel direction comprises matching the determined pixel direction to a header of a stored pixel decimation pattern. This provides a simple method of choosing the most suitable pixel decimation pattern from those stored by the encoder. Each pattern is stored with a header such as “vertical”, “horizontal” or “diagonal”, and this can be matched to the determined pixel direction within the specific macroblock, and this forms the selection procedure for obtaining the most suitable pixel decimation pattern.

Ideally, the step of determining a best encoding mode for the macroblock comprises determining the best intra mode for the macroblock. Depending upon the encoding scheme used in the encoder, this determination of the best encoding mode may be the determining of the best intra 16×16 mode. For example, this invention proposes a scheme for dynamic pixel decimation that is suitable for use in motion estimation for a H.264 video encoder. During mode decision in an H.264 encoder, an intra 16×16 mode is evaluated and a best intra 16×16 encoding mode is concluded. This best intra 16×16 encoding mode gives an indication of pixels correlation direction in a macroblock. This pixel correlation direction is exploited to skip the computation of SAD (sum of absolute differences) for few pixels in macroblock for motion estimation.

Embodiments of the present invention will now be described, by way of example only, with reference to the accompanying drawings, in which:—

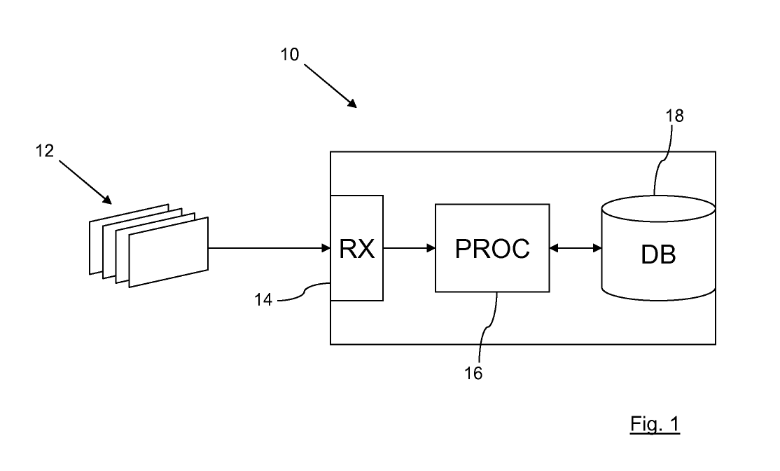

FIG. 1 is a schematic diagram of a system for video encoding,

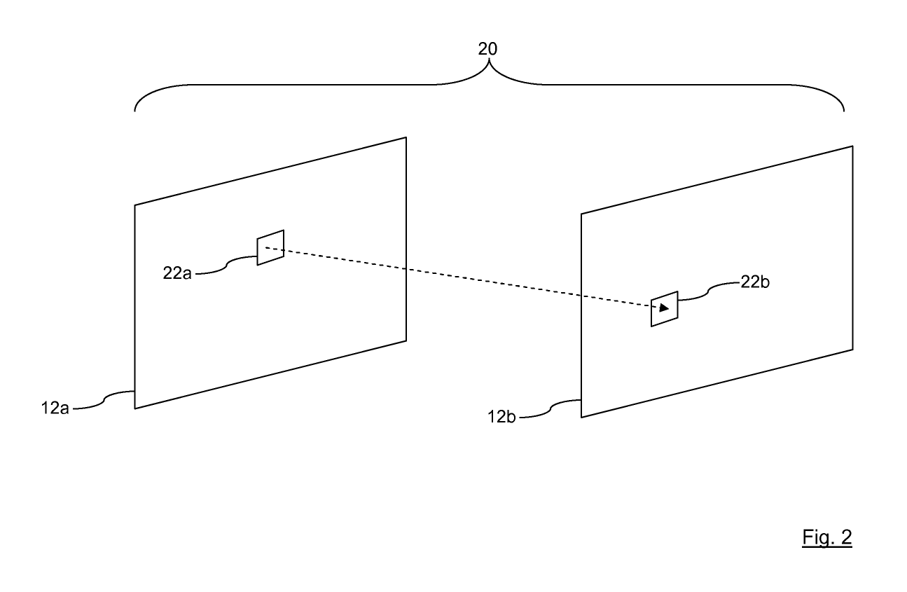

FIG. 2 is a schematic diagram of a pair of consecutive images in a video stream,

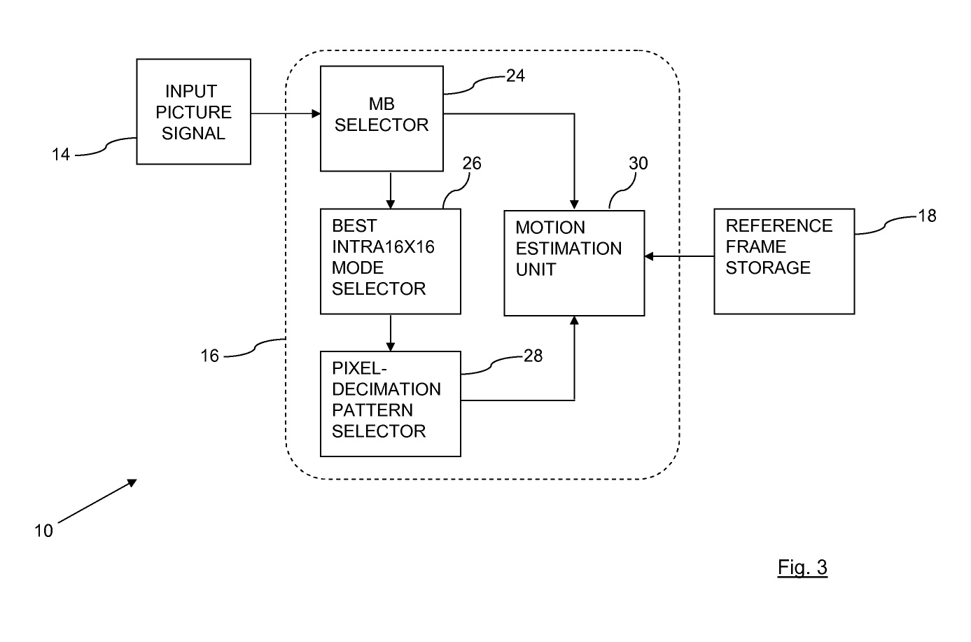

FIG. 3 is a schematic diagram of a video encoder, and

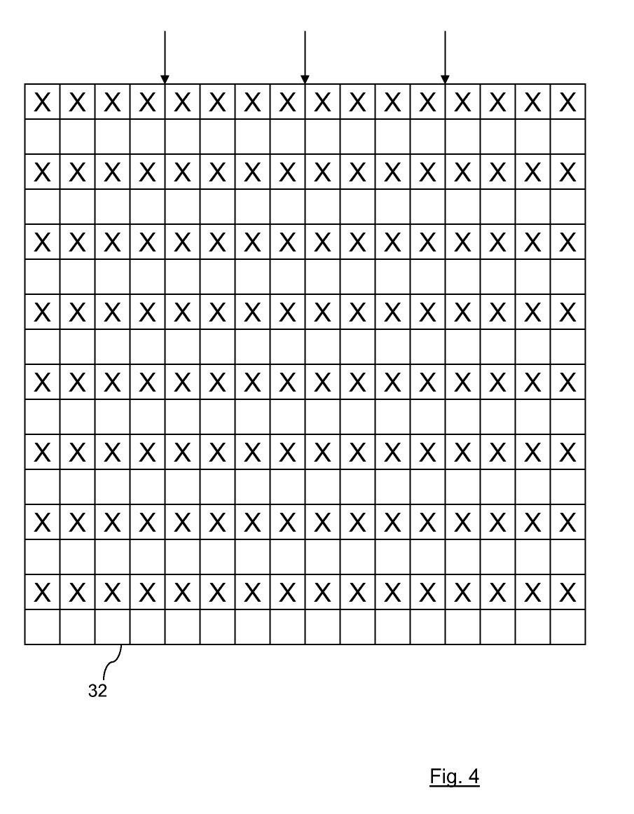

FIGS. 4 to 6 are schematic diagrams of pixel decimation patterns.

FIG. 1 shows an example of a system for video encoding, being a video encoder 10. The encoder 10 receives a series of images 12 at a receiver 14. These images 12 could be provided in real time by a camera, or could be being recalled from a suitable store, which is either local to the encoder 10 or could be connected remotely over a wide area network such as the Internet. The encoder 10 processes the images 12 at a processor 16 which is connected to a store 18. The store 18 can record the output of the processor 16, although this may be outputted directly in real time by the encoder 10. The store also provides information to the processor 16 that is used in the handling of the images 12. The store 18 can also be used to store reference pictures for motion estimation. These reference pictures are generated during the process of encoding. Also the output of the encoder 10, the compressed bitstream, can be outputted in separate block or realtime.

To provide to an end user with a video sequence that has sufficient realism of movement, at least thirty images a second need to be shown by the end user's display device (some schemes use fifty images a second). Since it is desirable to provide the end user with a video sequence that has a high resolution to improve the quality of the end image, the amount of data required to provide thirty high-quality images a second is very large, and creates a restriction/cost problem for the transmission channel to the end display device. To solve this problem, it is well known to use compression on the images 12 to reduce the amount of data that must be transmitted, without affecting the quality of the final output. Well known compression schemes include MPEG-2 and MPEG-4 part 10, also known as H.264.

One way in which compression occurs in schemes such as those mentioned above, is the use of motion estimation. FIG. 2 illustrates schematically the concept of motion estimation. This Figure shows a schematic diagram of a pair of consecutive images 12 in a video stream 20. The image 12a is the earlier image in time, and the image 12b is the next consecutive image in the stream 20. As will be appreciated, the stream 20 will contain a very large number of images 12. In compression schemes such as MPEG-2 and H.264, an image 12 is logically broken up into macroblocks of, for example, 16×16 pixels. An individual macroblock 22a is shown and marked in the image 12a, although for the purpose of explanation, the macroblock 22a is not to scale, being in reality much smaller relative to the size of the image 12a.

Part of the principal of the compression schemes that use motion estimation is that in closely related images (such as images 12a and 12b) elements will appear that are very similar, but have moved with respect to overall image. It is very common in all forms of video sequences for the camera to be held static for a period of time while only a small number of components move within the image. Since the time gap between images 12a and 12b could be as little as 1/30 or 1/50 of a second then a moving component (such as a football in an otherwise static shot) will not have altered appearance, but will have altered position. Effectively the same macroblock 22a appears in the image 12b, but as a new macroblock 22b in a new position. Rather than recoding the same macroblock 22b again for the new image 12b, a movement vector can be provided for that macroblock 22b which effectively says use the old macroblock 22a in the new image 12b.

However, the encoding process, as carried out by the processor 16 has to identify the macroblocks 22 that have moved. The operation of an H.264 video encoder is very computationally intensive one, especially software H.264 encoders. A good amount of the processor's cycles are spent on motion estimation alone. In order to be applicable for portable devices and mobile applications, computational complexity of the encoder has to come down. To reduce the complexity of motion estimation and at the same time not compromising with encoding efficiency dynamic pixel decimation has to be used in motion estimation. Pixel decimation means that when the processor is searching for the macroblock 22a in the later image 22b, only some of the pixels in the macroblock 22a are used in the matching process. However extra time will be required to determine the set of redundant pixels which need not be part of block matching computation, hence increasing some computation burden of motion estimation.

Towards this limitation of dynamic pixel decimation in motion estimation module in video encoders, the present invention proposes a new dynamic pixel decimation method for motion estimation, which can be used in, for example, an H.264 encoder. In such an H.264 video encoder, dynamic pixel decimation can be achieved without any extra computational cost which is otherwise required in finding the set of redundant pixels to be skipped from block matching computation.

In one embodiment of the invention Intra16×16 prediction mode assisted dynamic pixel decimation in used in motion estimation for an H.264 video encoder.

H.264 is a recent video coding standard jointly developed by ITU-T and MPEG bodies. The basic unit of encoding is a macroblock, containing 16×16 luma samples and associated chroma samples (8×8 Cb and 8×8Cr). In H.264 a macroblock can be coded as an intra macroblock or an inter macroblock. Intra macroblocks are predicted using intra prediction from already decoded neighbouring samples in the current frame. A prediction is formed either (a) for the complete macroblock or (b) for each 4×4 blocks of luma and associated chroma samples. Inter macroblocks are predicted using inter prediction from reference frame(s). An inter coded macroblock may be divided into smaller blocks, of size 16×16, 16×8, 8×16, 8×8, 8×4, 4×8, 4×4 luma samples and associated chroma samples, for prediction. Once the macroblock prediction is formed each 4×4 block residual is formed by subtracting the prediction from original pixels followed by transform, quantization and VLC encoding.

In order to determine the encoding mode (intra or inter) of a macroblock, intra mode and inter mode (motion estimation) evaluation has to be done for each macroblock of the frame. In order to decide the encoding mode of a macroblock along with partition size one has to compute macroblock SAD (sum of absolute differences of co-located pixels) for that particular mode. Hence as part of mode decision, the encoder 10 has to always find a best intra mode (such as the best intra 16×16 mode with minimum SAD). This best intra 16×16 mode will be compared with best inter mode and with best intra 4×4 mode and the macroblock mode with minimum SAD will be chosen as encoding mode of the macroblock. This invention uses the best intra 16×16 mode information for dynamic pixel decimation in motion estimation in H.264 Encoder. The best Intra16×16 mode will be available as part of mode decision in an H.264 encoder, hence it will not cost any additional CPU cycles as for as its usage for dynamic pixel decimation is concerned.

FIG. 3 shows in more detail the working of the encoder 10 of FIG. 1. The input picture signal, the image 12, will be segmented into macroblocks (MB) of size 16×16. The MB selector 24 will select macroblocks in raster scan order from the input picture 12 for processing. For the current selected macroblock, the best intra 16×16 encoding mode will be evaluated first at the selector 26 and the same will be input to for pixel decimation pattern selector block 28. The pixel decimation pattern selection is described in more detail below.

The selected pixel decimation pattern will be used for the current macroblock's motion estimation. The motion estimation unit 30 shown in the Figure is a generic one. Its operation is described in detail in document United States of America Patent U.S. Pat. No. 5,475,446, referred to above. The dynamic pixel decimation scheme used by an encoder 10 as described with reference to FIGS. 1 and 3 above, which is applicable for an H.264 video encoder can work with any motion estimation algorithm like Full Search, Three Step Search Method etc. The above process will be repeated for all the macroblocks in the input image 12.

The processor 16 is arranged to select a macroblock 22 of the image 12, to determine the best encoding mode for the macroblock 22 (which may be the best intra encoding mode), to determine a pixel correlation direction from the determined best encoding mode, and to select a pixel decimation pattern according to the determined pixel direction. The processor 16 is further arranged to repeat the process for each macroblock in the image. The store 18 is arranged to store the plurality of pixel decimation patterns that are used by the processor in the motion estimation. The store 18 is also for storing reconstructed pictures (also used as reference pictures in motion estimation). Instead of using the store 18, pixel decimation patterns can be stored in pixel decimation pattern selector unit 28.

In one embodiment, each stored pixel decimation pattern includes a header defining a pixel correlation direction. The processor 16 is arranged, when selecting a pixel decimation pattern according to the determined pixel direction to match the determined pixel direction to a header of a stored pixel decimation pattern.

The processor 16 is arranged, when determining a best encoding mode for the macroblock, to determine the best intra 16×16 mode for the macroblock. There are four Intra 16×16 modes available in the H.264 coding standard. These are named vertical, horizontal, plane and DC. Each mode is suitable to predict directional structures in the images at different angles (e.g. vertical, horizontal, diagonal). If a structure is oriented in the horizontal direction in an image then for the macroblock containing that structure, the best intra 16×16 mode is likely to be the horizontal mode. In other words, the best intra 16×16 mode indicates predominant pixel correlation direction in the 16×16 macroblock. Based on the best intra 16×16 mode the processor 16 can infer the pixels correlation direction in the macroblock and accordingly few redundant pixels can be omitted from the SAD computation for the motion estimation, thus achieving dynamic pixel decimation based on the best intra 16×16 mode in an H.264 encoder. The details of the pixel decimation scheme for motion estimation of a macroblock for each best intra 16×16 mode case are given below.

FIG. 4 shows a pixel decimation pattern 32 which relates to a 16×16 macroblock and each cell of the table corresponds to a pixel of the macroblock. The cell (pixel) marked with X will be part of the block matching computation whereas the empty cell will be skipped from the block matching computation. The arrows indicate the prediction direction for the corresponding best intra 16×16 mode, which means pixels in the macroblock, will have more correlation in the direction indicated by arrow compared to other directions. This Figure shows an example of a pixel decimation pattern 32 that will be used when the best intra 16×16 mode is the vertical mode.

When the best intra 16×16 mode is vertical, then the pixels in the specific macroblock have more correlation in the vertical direction and therefore alternate pixels are skipped in the vertical direction to save the computation in motion estimation. It is clear from FIG. 4 that out of 256 pixels in the 16×16 macroblock, half the pixels will be skipped from the block matching computation.

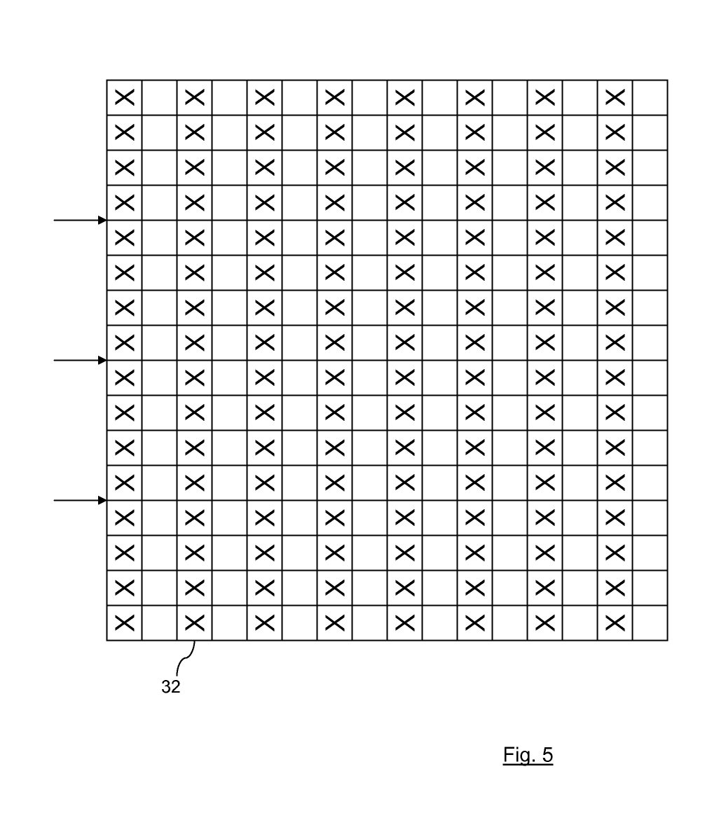

When the best intra 16×16 mode is determined to be the horizontal, then pixels have more correlation in horizontal direction and therefore alternate pixels are skipped in horizontal direction to save the computation in motion estimation. FIG. 5 shows a suitable pixel decimation pattern when the best intra 16×16 mode is the horizontal case. It is clear from the Figure that out of 256 pixels in a macroblock, half the pixels will be skipped from the block matching computation. The processor 16 will select this pattern when it is determined that the pixel correlation direction in the macroblock is in the horizontal direction.

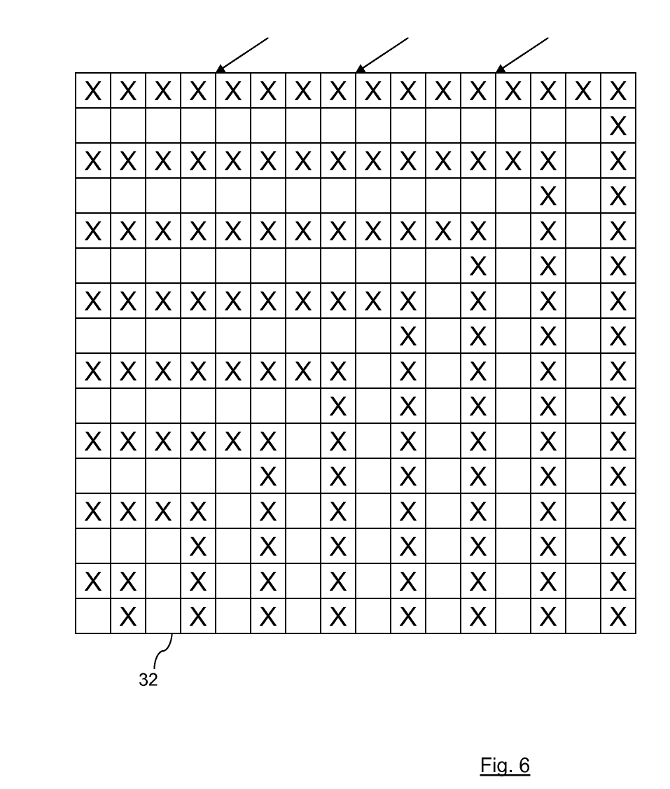

When the best intra 16×16 mode is plane, then the pixels have more correlation in the diagonal direction and therefore alternate pixels are skipped in a diagonal direction to save the computation in motion estimation. FIG. 6 shows the best intra 16×16 mode in the plane case. It is clear from the Figure that out of 256 pixels in a macroblock, 120 pixels will be skipped from the block matching computation. The arrows in the Figure illustrate the detected direction within the macroblock.

If the best intra 16×16 mode is detected to be the DC, then pixels in macroblock do not have any preferential correlation direction and hence all the pixels can be used for block matching computation for better encoding efficiency. No pixel decimation is carried out in this case.

As explained above, alternate pixels are skipped for block matching computation in the direction of pixel correlation in macroblock (given by the best intra 16×16 mode). In respect of the vertical mode, the effect of the use of the pixel decimation is that alternate rows of macroblock are taken for block matching computation. This concept can be extended by skipping more than one pixel for each pixel that is actually used, for the block matching computation e.g. for each pixel taken in for computation three pixels can be skipped. This will be equivalent to taking one row of macroblock for block matching computation and skipping subsequent three rows for computation in Vertical mode case. The same concept can be applied for the other two modes (horizontal and plane) also.

The actual design of the pixel decimation patterns is not material to the invention. The improved encoder provides a dynamic choice of pixel decimation patterns based upon the information from the best mode, which is already present within the encoding process. This best mode is used to determine the general (or most prevalent) direction of the pixels within a specific macroblock, and this information is used to automatically select the desired pixel decimation pattern that will be used for the specific macroblock. Other macroblocks within the image may use the same or different pixel decimation patterns depending upon the best mode selection for each individual macroblock. FIGS. 4 to 6 give examples of pixel decimation patterns that can be used effectively for three specific pixel correlation directions. Other patterns could be used for these directions, and indeed other additional directions could be used to select the pattern. The encoder provides dynamic pixel decimation without needing any additional processor cycles as if currently the case with existing encoders. Applications of the invention include its use for portable video devices and in mobile applications. The invention provides dynamic pixel decimation in motion estimation for H.264 encoder based on the best intra 16×16 prediction mode.

1. A method for video encoding comprising
receiving an image (12),
selecting a macroblock (22) in the image (12),
determining a best encoding mode for the macroblock (22),
determining a pixel direction from the determined best encoding mode, and
selecting a pixel decimation pattern (32) according to the determined pixel direction.

2. A method according to claim 1, and further comprising repeating the selecting a macroblock (22) in the image (12), determining a best encoding mode for the macroblock (22), determining a pixel direction from the determined best encoding mode, and selecting a pixel decimation pattern (32) according to the determined pixel direction, for each macroblock (22) in the image (12).

3. A method according to claim 1 or 2, and further comprising storing a plurality of pixel decimation patterns (32).

4. A method according to claim 3, wherein each stored pixel decimation pattern (32) includes a header defining a pixel direction.

5. A method according to claim 4, wherein the step of selecting a pixel decimation pattern (32) according to the determined pixel direction comprises matching the determined pixel direction to a header of a stored pixel decimation pattern (32).

6. A method according to any preceding claim, wherein the step of determining a best encoding mode for the macroblock (22) comprises determining the best intra 16×16 mode for the macroblock (22).

7. A system for video encoding comprising
a receiver (14) arranged to receive an image (12), and
a processor (16) arranged to select a macroblock (22) in an image (12), to determine a best encoding mode for the macroblock (22), to determine a pixel direction from the determined best encoding mode, and to select a pixel decimation pattern (32) according to the determined pixel direction.

8. A system according to claim 7, wherein the processor (16) is further arranged to repeat the selecting a macroblock (22) in the image (12), determining a best encoding mode for the macroblock (22), determining a pixel direction from the determined best encoding mode, and selecting a pixel decimation pattern (32) according to the determined pixel direction, for each macroblock (22) in the image (12).

9. A system according to claim 7 or 8, and further comprising a store (18; 28) arranged to store a plurality of pixel decimation patterns (32).

10. A system according to claim 9, wherein each stored pixel decimation pattern (32) includes a header defining a pixel direction.

11. A system according to claim 10, wherein the processor (16) is arranged, when selecting a pixel decimation pattern (32) according to the determined pixel direction comprises, to match the determined pixel direction to a header of a stored pixel decimation pattern (32).

12. A system according to any one of claims 7 to 11, wherein the processor (16) is arranged, when determining a best encoding mode for the macroblock (22), to determine the best intra 16×16 mode for the macroblock (22).

13. A computer program product on a computer readable medium for video encoding, the product comprising instructions for
receiving an image (12),
selecting a macroblock (22) in the image (12),
determining a best encoding mode for the macroblock (22),
determining a pixel direction from the determined best encoding mode, and
selecting a pixel decimation pattern (32) according to the determined pixel direction.

14. A computer program product according to claim 13, and further comprising instructions for repeating the selecting a macroblock (22) in the image (12), determining a best encoding mode for the macroblock (22), determining a pixel direction from the determined best encoding mode, and selecting a pixel decimation pattern (32) according to the determined pixel direction, for each macroblock (22) in the image (12).

15. A computer program product according to claim 13 or 14, and further comprising instructions for storing a plurality of pixel decimation patterns (32).

16. A computer program product according to claim 15, wherein each stored pixel decimation pattern (32) includes a header defining a pixel direction.

17. A computer program product according to claim 16, wherein the instructions for selecting a pixel decimation pattern (32) according to the determined pixel direction comprises instructions for matching the determined pixel direction to a header of a stored pixel decimation pattern (32).

18. A computer program product according to any one of claims 13 to 17, wherein the instructions for determining a best encoding mode for the macroblock (22) comprises instructions for determining the best intra 16×16 mode for the macroblock (22).
